(19) United States
(12) Patent Application Publication
(10) Pub. No.: US 2009/0089366 A1
(43) Pub. Date: Apr. 2, 2009

(54) PORTABLE CACHING SYSTEM

(76) Inventor: Kalman Csaba Toth, Portland, OR (US)

Correspondence Address: GANZ LAW, P.C., P O BOX 2200, HILLSBORO, OR, 97123, US

(21) Appl. No.: 12/032,632

(22) Filed: Feb. 15, 2008

Related U.S. Application Data
(60) Provisional application No. 60/975,770, filed on Sep. 27, 2007.

(51) Int. Cl. G06F 15/16; G06F 9/54

(52) U.S. Cl. 709/203; 719/327

(57) ABSTRACT

A portable caching system is described that is composed of a user workstation, a prior art web browser executing on the user workstation, a portable caching device, a portable caching device driver, a cache manager, and a user carrying a portable caching device. A method for handling the browsing operations as integrated with the portable caching system is described, the method detecting if the portable caching device is present, directing a portion of the browsing operations, and performing the operations: open the home page, open, download, and upload files, open and update browsing history, open and update download history, open and update upload history, open bookmarks, read and write cookies; use certificates, use private encryption keys, use and update revocation list entries; use logon objects including website addresses, identifiers, and passwords.

### RELATED APPLICATIONS

This application claims the benefit of and priority to U.S. Provisional Application Ser. No. 60/975,770, filed Sep. 27, 2007, the contents of which are hereby incorporated by reference as if recited in full herein for all purposes.

### BACKGROUND

The present invention relates to personalizing and securing a user's web browsing experience and current browsing state across one or more workstations. More particularly, the present invention relates to using a portable caching system that contains personal information of the user that can be used in conjunction with web browsers executing on various user workstations. Further, the present invention physically and logically secures the user's personal, private and secret information and attributes by maintaining this information within the portable caching device thereby mitigating risks of information loss, theft, and corruption.

Web browsers are software programs that execute on client computers that enable users to perform web browsing operations against resources stored across computers that collectively compose the web. Web browser operations include accessing, opening, viewing, updating, copying, saving, and deleting web resources such as word documents, images, spreadsheets, and executable software programs. Web browsers may be configured to execute on various types of user workstations including desktop and laptop personal computers (PCs), kiosks and internet workstations, cell phones, and Personal Digital Assistants (PDAs). Web browsers can also be incorporated into special purpose workstations such as Automated Teller Machines (ATMs) and Point-of-Sale (POS) terminals.

Web browsers on personal computers and hand-held devices are used globally to access personal and private information stored in electronic records, files and databases across all economic sectors. These sectors include health care, finance, banking, law enforcement, government, education, non-profits, purchasing, e-commerce, supply chains, transportation and enterprise computing. Workstations and browsers are increasingly shared by enterprise workers, employees, agents, private citizens, and consumers across these application domains.

There is a substantial need for improvements to the personalization of web browsing. Personalization has been a highly attractive and rapidly growing feature of web-based systems since 1990. Meanwhile, the multifaceted challenge of securing personal and enterprise information and systems has outpaced the exponential growth of the Internet since 1990.

Many operational scenarios have been documented in the literature where the indiscriminant sharing of web browsers has been shown to be a common but unfortunate practice. Prior art browsers, such as Microsoft's Internet Explorer and Mozilla Firefox, do not segregate the personal information of users sharing the browser which poses both privacy and security risks. A possible risk mitigation strategy would be to use operating systems that support user accounts and passwords to segregate users. However, users can mistakenly leave accounts open for others to use and are not aware of the risks of sharing the use of their passwords.

Conventional web programming practices are also problematic. For example, a powerful business feature of many web services is to personalize web usage on behalf of each user. Personal information may be used to personalize the web user's experience, for example to present the user with products of relevant interest, by depositing fragments of the user's identity or personal data into web cookies. Browser sharing and multi-browser usage complicate such personalization strategies. When a user switches to another browser, their personal information and cookies are left behind in a previous browser context which could be accidentally or intentionally used and exploited by a subsequent user of the browser.

Also problematic is the way that conventional browsers endeavor to support secure sessions of the user by maintaining prior-use credentials within their browser contexts, in particular, passwords, digital certificates and private encryption keys. Such credentials could also be exploited by subsequent users. Furthermore, when a user moves to another web browser, such credentials would need to be reentered, re-created, imported, or re-acquired by the user which is a major inconvenience and is prone to user error.

Personalization of an automated web system or service is achieved by presenting personal information and attributes that characterize the user to the system or service. The automated behavior of such systems is modulated by the personal information of the user. The behaviors of these systems and services will tend to evolve over time in concert with the attributes, preferences, browsing tendencies and other personal information of the user.

A pivotal precondition of such automated personalization is that the personal information of the user is consistently and accurately bound to that user at all times. Such binding can be achieved by physical, logical, and algorithmic means. For example:
The user can physically own or control a device containing their personal information.
A secret of the user, such as a password, can be processed by software logic to authenticate the user and mediate access to their personal information.
An encryption or hashing algorithm modulated by a secret key of the user can be used to hide and reveal their personal information.

When browsing the web a user will use personal, private and secret information to access web resources. Furthermore, some of the web resources visited by the user may contain fragments of their personal, private, and secret information. For example, a user may use a secret password to access their private medical records, banking transactions, or personal email messages and files.

Personal information of the user can be categorized as follows:
Data: Files, transactions, and database records containing personal, private or secret information of the user including names, locations, and directories of such files, transactions, and records that may be stored on a designated local or remote storage or computing device available to the user;
Identifiers: Legal names, nick names, pseudo names and other identifiers of the user such as social security, credit card, employee, bank account, passport numbers;
Attributes/preferences: Roles, responsibilities, purchasing, reading and entertainment interests, etc. of the user;
Home page: Web page designated by the user to be the first page to open during a browsing session;
Web browsing history: List of web sites, services, and resources visited by the user;
Web download history: List of files downloaded by the user;
Web upload history: List of files uploaded by the user;
Browsing habits: Addresses of web sites, services, and resources (a.k.a. “favorites”) bookmarked by the user;
Web cookies: Text strings specified by web services visited by that user that include the internet address of the service and possibly other information specified by the service;
Personal digital certificates: Digital certificates acquired by the user for authentication and security purposes that may contain user identities, attributes, and personal information of the user;
Secrets: Logon and service access passwords and private encryption keys assigned to or belonging to the user.

As indicated above, personal information of the user is subject to several vulnerabilities, also known as security risks. These vulnerabilities include both intentional and accidental loss, identity theft, and destruction of a user's personal information. A user's personal information can be fraudulently used and thereby exploited for personal gain.

Web browsers by necessity capture personal information of the user while being used, and retain much of this information after use within the web browser's memory. This collection of information is commonly called the “browser context”. Users often elect to use multiple workstations, for example, PCs at home, at work, at Internet cafes, or borrowed cell phones and PDAs. Such users will leave various fragments of their personal, private and secret information stored within the web browser context of the various workstations they happen to use.

Because of the prolific nature of web browsing, most users' personal and private information, and sometimes even their secret information, may be left in inadequately secured repositories scattered across the web. Furthermore, users habitually bookmark favorite web resources, including resources that may contain their personal and private information, thereby indirectly exposing their information to possible exploit.

These vulnerabilities can be attributed to web browser sharing and sharing of workstations and other such terminal devices upon which such web browsers execute. Typically, these user workstations are shared among a plurality of users who do not necessarily trust each other to make ethical and proper use of the personal information of others that may be left behind within a given web browser context.

Web browsers available today do not securely segregate the personal information of multiple users. Cell phones and PDAs tend to be more personally held and mitigate some of these vulnerabilities. However, these devices are often shared among family members, friends and co-workers; users rarely enable locking codes and passwords when available; and these devices are occasionally lost and stolen.

The prior art discloses a physical device that resembles an USB memory card that when inserted into the computer can execute an application. Also described in the prior art are “smart cards” which are media devices that contain executable code and memory. The smart cards interface to a “smart card reader” for communicating with a terminal device or workstation. Likewise, the prior art includes portable computers, personal digital assistants, cell phones, and other devices that are portable, are programmable, and have a memory store. These devices may also have an authentication mechanism. This mechanism implements a trust relationship between the device holder and the user.

The prior art also describes software and systems for creating multiple software identities for multiple persons to use such software applications as email, user titles, and other functionality. Other art also describes systems, methods, and apparatus for personal identity data management for such items as criminal and employment background checks. Also described are software and systems where the browser is configured to use desired user preferences based on entering a user identifier. Similarly the prior art depicts bookmark-managing software wherein the bookmarks are maintained on a web site and linked to a particular user identifier for subsequent reference and use. The prior art also discloses a smart card used to store personal digital certificates and private encryption keys of the user that are associated with and used by a web browser.

Neither does the prior art address the range of security, privacy and flexibility needs of the user, nor the advantages of using a removable cache containing the personal information, web browsing experience, and browsing state of the user, such as, browsing history, download history, upload history, bookmarks, cookies, personal certificates and private encryption keys, certificates of others including web sites and certificate authorities, logons, files and other user attributes and preferences.

This invention solves the user's need to cache their personal information and web browsing experience and state in a personal device that may be physically moved from workstation to workstation. This invention enhances the user's privacy and security by avoiding the problems of leaving behind sensitive and personal information within the storage of user workstations after their use.

### SUMMARY

The inventive subject matter overcomes the aforementioned problems by providing a portable caching system for web browsing that is portable across different user workstations.

In certain respects it is directed to a portable caching system for internet browsing, the portable caching system includes: a cache manager, the cache manger operable to exchange data with a web browser; and to exchange data with a portable caching device, the portable caching device also operable to communicate with the cache manager; wherein at least one transaction may pass from the web browser to the cache manager, and the transaction is further communicated to the portable caching device; wherein at least one transaction may pass from the portable caching device to the cache manager, and the transaction is further communicated to the web browser.

In certain embodiments, the portable caching system is integrated with the web browser software as provided by the manufacturer. In other embodiments, the portable caching system is provided as software that is installed after the web browser is installed.

In certain embodiments the portable caching device includes USB stick memories, smart cards, cell phones, smart phones, and personal digital assistants used in conjunction with web browsers executing on separate user workstations.

The inventive subject matter stores the user's identifiers, digital certificates, private encryption keys, passwords, and other personal information and attributes, including home page, files, browsing history, download history, upload history, bookmarks, and cookies, within the user's portable caching device. The user's web browsing experience and personality are thereby portable and can be conveniently associated with a plurality of web browsers and workstations.

The inventive subject matter will yield economic benefits in domains that require convenient, personalized, mobile, private and secure management of personal information for the user. Indeed, some of this personal information may be sensitive, private and secret from the perspective of the user. The inventive subject matter captures home page, browsing history, download history, upload history, web site preferences (i.e., bookmarks/favorites), and cookies, binding them to the user and thereby memorizing the user's personal information as the user roams from workstation to workstation.

The various embodiments and domains described herein should not be construed as limitations in the potential application of the invention. Rather they are teachings for the purpose of illustrating the ramifications and variations of possible embodiments of this invention.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1 is a systems diagram depicting the spectrum of user workstations exchanging data with the portable caching device over the internet.

FIG. 2 is a diagram of the inventive device, a memory media device, a smart card device, and a smart phone device; wherein each device is suitably connected to the user workstation.

FIG. 3 is a diagram of the prior art showing the relationships between a user, a web browser, the internet, a browser context, context operations, and browser operations.

FIG. 4 is a diagram of the prior art web objects and logical associations composing the browser context.

FIG. 5 is a diagram of the inventive portable caching system showing the relationships between a web browser, a portable caching device, the cache context of the portable caching device, a cache manager, and a portable caching device driver.

FIG. 6 is a diagram of web objects and logical associations composing the cache context of a portable caching device.

FIG. 7 is a software activity diagram showing the installation and operation of the cache manager integrated into the web browser of the portable caching system.

### DETAILED DESCRIPTION

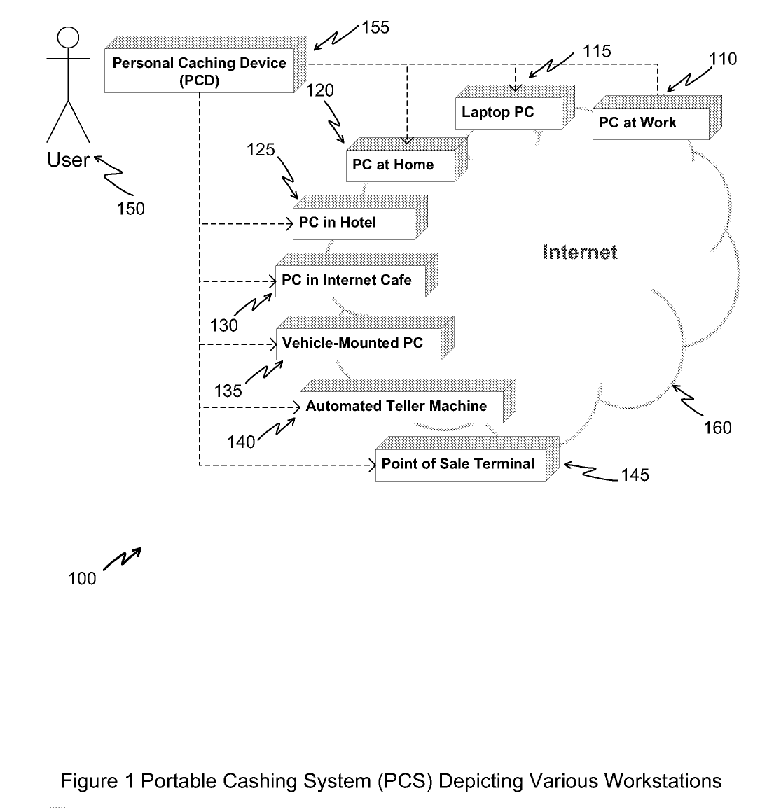

Representative embodiments according to the inventive subject matter are shown in FIGS. 1 to 7, wherein similar features share common reference numerals. The specific embodiments are meant to be illustrative and not limiting of the scope of the invention and the various ways it may be embodied.

The inventive subject matter is a portable caching system (hereinafter “PCS”). The PCS includes an executable web browser application software module termed a cache manager (hereinafter “CM”) and a portable caching device (hereinafter “PCD”). The CM communicates with the PCD. The PCD consists of a “Cache Context” (hereinafter “CC”) which is a store of web objects maintained within the PCD. The PCD is typically a small form factor device that is portable. The term “PCD” refers to, for example, a memory media device such as a memory stick possibly with a USB interface, a smart card with smart card reader, a portable electronic device with memory, such as, a cell phone or a digital camera, or a programmable hand-held device like a smart phone or personal digital assistant (PDA). PCD devices share a common feature in that they have an electronic memory store, are portable, and can connect to a user workstation that is capable of executing a web browser.

Now referring to FIG. 1 which is a diagram of the PCS depicting various workstations 100 that use the inventive subject matter. The term “workstation” describes a general purposes computer, including, but not limited to: a personal computer at work 110, a laptop personal computer 115, a personal computer at home 120, a personal computer in a hotel 125, a personal computer in an internet cafe 130, a vehicle-mounted personal computer 135, a personal computer integrated into an automated teller machine 140, and a point-of-sale terminal personal computer 145. These devices are usually connected to the internet 160 and are used for web browsing by the user 150 while using the PCD 155.

The term “internet” generally refers to an asynchronous computing network well known to those skilled in the arts as the “World Wide Web” or simply the “Web”, but, also refers to local private networks that use the same standards and protocols employed by the internet.

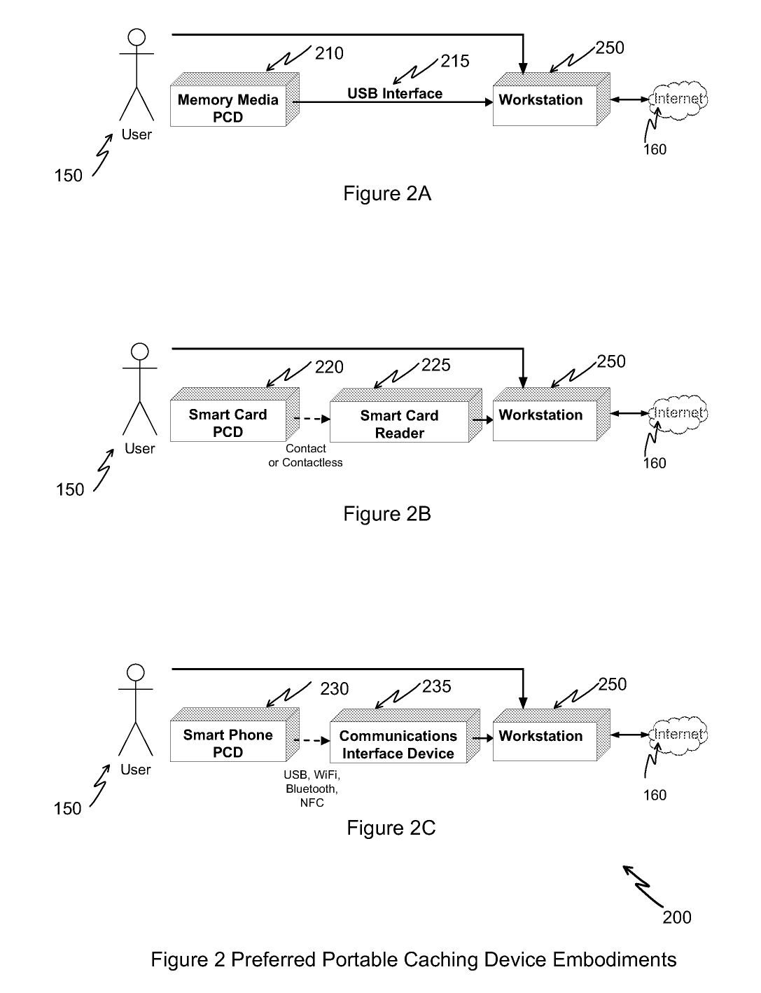

FIG. 2 illustrates three configurations of the PCS. FIG. 2A depicts the PCS having a memory media embodiment in the PCD; FIG. 2B depicts the PCS having a smart card embodiment in the PCD; FIG. 2C illustrates the PCS as having a smart phone embodiment as the PCD.

The term “memory media” depicted in FIG. 2A refers to a thumb-sized integrated circuit embedded in plastic or similar material that contains non-volatile random access memory for the purpose of storing data exchanged with another electronic device such as a workstation through a USB cable or similar connection.

Now referring to FIG. 2A which shows a memory media PCD embodiment 210. The memory media PCD 210 is physically carried by the user 150 providing physical security. A USB interface 215 is electrically connected to a workstation 250. The user 150 interacts with the workstation 250 for the purpose of browsing the internet 160. Furthermore, the user 150 connects the memory media PCD 210 to the USB interface 215 and thereby exchanges personal information of the user between the memory media PCD 210 and the workstation 250 for the purpose of personalizing and securing web operations while browsing the internet 160. The user 150 removes the memory media PCD 210 from the USB interface 215 of the workstation 250 once web browsing has been completed.

The term “smart card” depicted in FIG. 2B generally refers to a plastic card roughly the size of a credit card with an embedded integrated circuit that contains non-volatile random access memory and a microprocessor for the purpose of storing and operating on data exchanged with a smart card reader. At least two types of interfaces between smart cards and smart card readers may be used. A first type of smart card interface allows the smart card to be physically inserted into a slot in the smart card reader wherein electronic contacts of the integrated circuit of the smart card make physical contact with electronic contacts in the slot of the smart card reader. A second type of smart card reader allows the smart card to be positioned within close proximity of the smart card reader using limited distance radio signals to exchange data between the devices; such smart cards and smart card readers are commonly termed “contactless”. The term “exchange data” and “communicate” should be considered synonymous such that they refer to the movement of data whether it is accomplished by wire or wireless and independent of protocol.

Now referring to FIG. 2B which shows a smart card PCD embodiment 220. The smart card PCD 220 is physically carried by the user 150 providing physical security. A smart card reader 225 is electrically connected to a workstation 250. The user 150 interacts with the workstation 250 for the purpose of browsing the internet 160. Furthermore, the user 150 introduces the smart card PCD 220 to the smart card reader 225 and thereby exchanges personal information of the user between the smart card PCD 220 and the workstation 250 for the purpose of personalizing and securing web operations while browsing the internet 160. The user 150 removes the smart card PCD 220 from the smart card reader 225 once web browsing has been completed.

The term “smart phone” depicted in FIG. 2C refers to a programmable cellular phone with integral memory and processing unit that utilizes such technologies as Java, .Net and/or Palm OS to program and execute embedded and downloaded application programs. A smart phone may exchange information with other electronic devices including workstations through USB cable connections and through limited distance radio technologies implementing the IEEE 802.11 series wireless communications standard (commonly known as “WiFi”), Bluetooth, Near Field Communications (“NFC”) or similar wireless technology.

Now referring to FIG. 2C which shows a smart phone PCD embodiment 230. The smart phone PCD 230 is physically carried by the user 150 providing physical security. A communications interface device 235 is electrically connected to a workstation 250. The user 150 interacts with the workstation 250 for the purpose of browsing the internet 160. Furthermore, the user 150 introduces the smart phone PCD 230 to the vicinity or proximity communications interface device 235 and thereby exchanges personal information of the user between the smart phone PCD 230 and the workstation 250 for the purpose of personalizing web operations while using the workstation 250 to browse the internet 160. The user 150 removes the smart phone PCD 230 from the vicinity or proximity communications interface device 235 once web browsing has been completed.

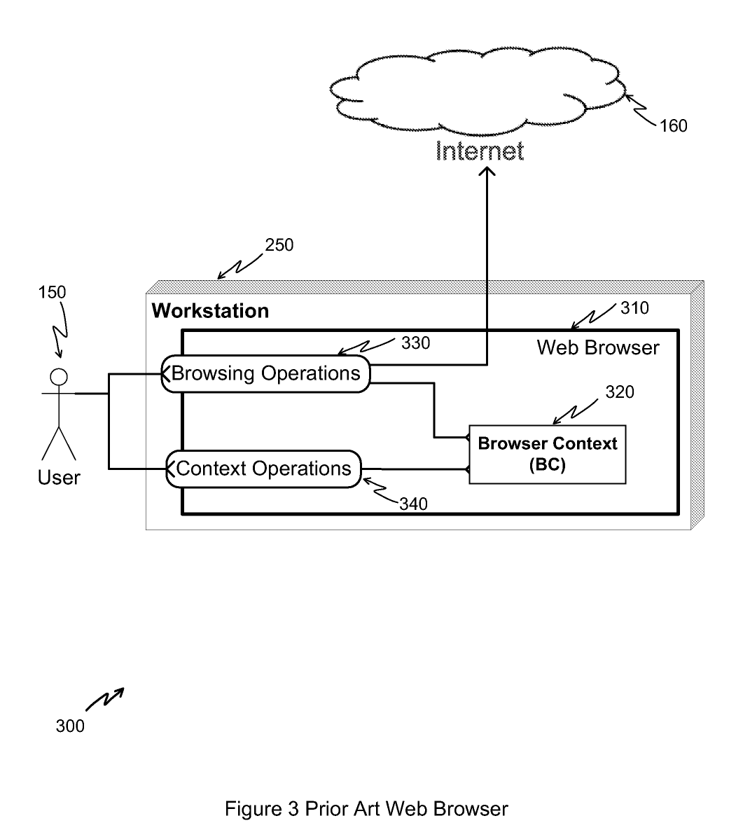

A “web browser”, which is depicted in FIG. 3, is defined as a software application that can initiate and respond to internet transactions using HTTP, HTTPS, FTP, FTPS and other such internet communications protocols.

Now referring to FIG. 3 which depicts a prior art web browser 300. A web browser 310 is associated with a user 150 and a workstation 250 which is connected to the internet 160 as previously described in FIG. 1. The internet 160 is interfaced to the workstation 250 which consists of a web browser 310. The web browser 310 consists of a browser context (hereinafter “BC”) 320, browsing operations 330 and context operations 340. Browsing operations 330 initiate and respond to internet transactions. Furthermore, browsing operations 330 open, upload, download, read, write, update, and otherwise use web objects contained in the BC 320 (i.e. browser context). Context operations 340 view, update, delete, save, import, and export web objects in the BC 320 (i.e. browser context).

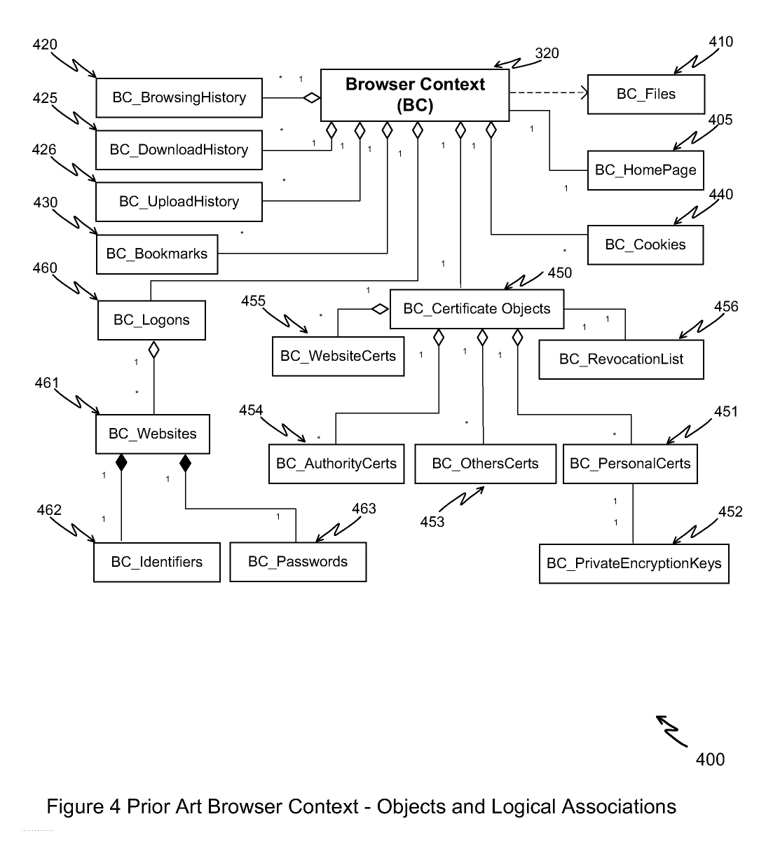

Now referring to FIG. 4 which depicts the web objects 400 of the BC 320 (i.e. browser context) that are operated upon by browsing operations 330 and context operations 340 of the web browser 310 of FIG. 3. The BC 320 is associated with BC home page 405, BC files 410, BC browsing history 420, BC download history 425, BC upload history 426, BC bookmarks 430, and BC cookies 440. The BC 320 further has BC certificates 450 that is composed of BC personal certificates 451, BC private encryption keys 452, BC others certificates 453, BC authority certificates 454, BC web site certificates 455, and a BC revocation list 456. The browser context 320 in addition has BC logons 460 composed of associated BC web sites 461, BC identifiers 462, and BC passwords 463. The BC identifiers 462 are paired with BC passwords 463 to form an “identifier and password pair”.

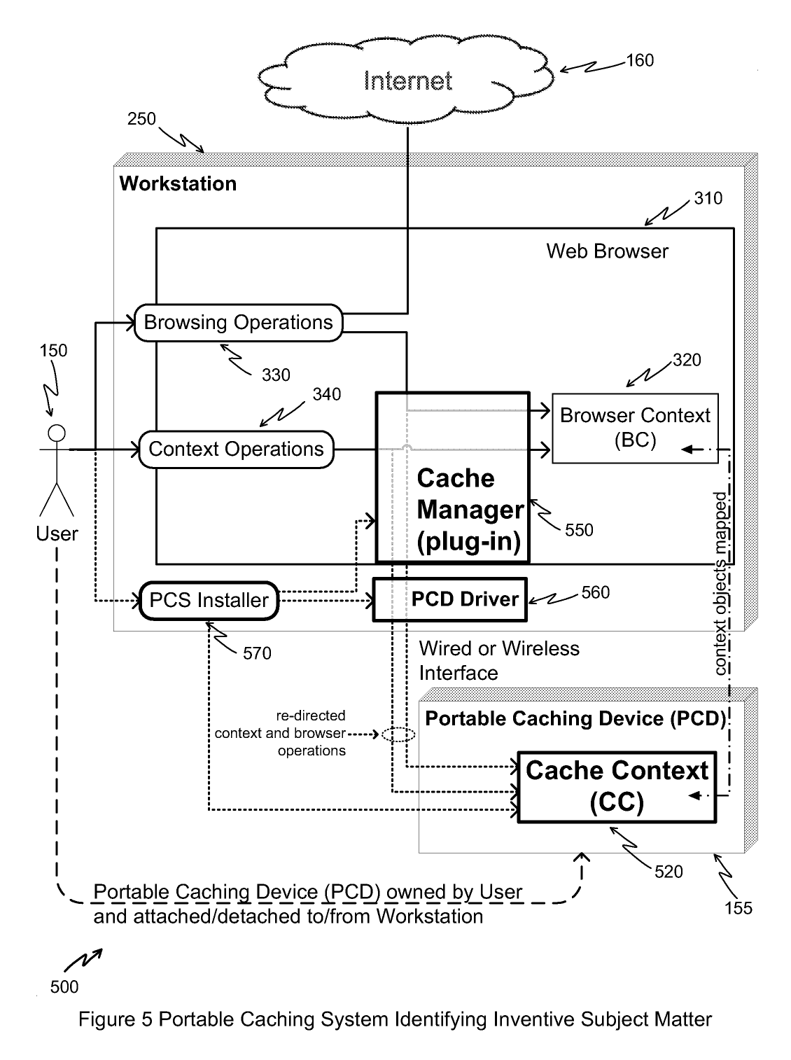

Now referring to FIG. 5 which is a design diagram 500 of the PCS depicting the prior art web browser of FIG. 3 modified by the additional components comprising the inventive subject matter. A user 150 uses a workstation 250 executing a web browser 310 to browse the internet 160 by means of browsing operations 330, and context operations 340. The additional inventive subject matter of the PCS identified in FIG. 5 is a PCD (portable caching device) 155, a cache context (hereinafter “CC”) 520, a PCD driver 560, a cache manager 550 (hereinafter “CM”), and a PCS installer 570. As previously described in FIG. 2, memory media 210, smart cards 220 and smart phones 230 are preferred embodiments of the PCD. The CC 520 (cache context) of a PCD 155 consists of web objects that are mapped to equivalent web objects of the BC 320 (browser context) by the CM 550 (cache manager). The PCD driver 560 is a software component that executes on the workstation 250 that communicates with the PCD 155 and the CM 550. The CM 550 (cache manager) is a software program, also termed a software “plug-in”, which is embedded within or integrated with the web browser. The CM 550, by means of the PCD driver 560, directs browser operations 330 and context operations 340 to operate on equivalent web objects of the BC 320 (browser context) and the CC 520 (cache context). The PCS installer 570 installs the CM 550 and the PCD driver 560. Furthermore, the PCS installer 570 integrates the CM 550 and PCD driver 560 with the prior art web browser 300. In addition, the PCS installer formats and initializes the PCD 155 and the CC 520.

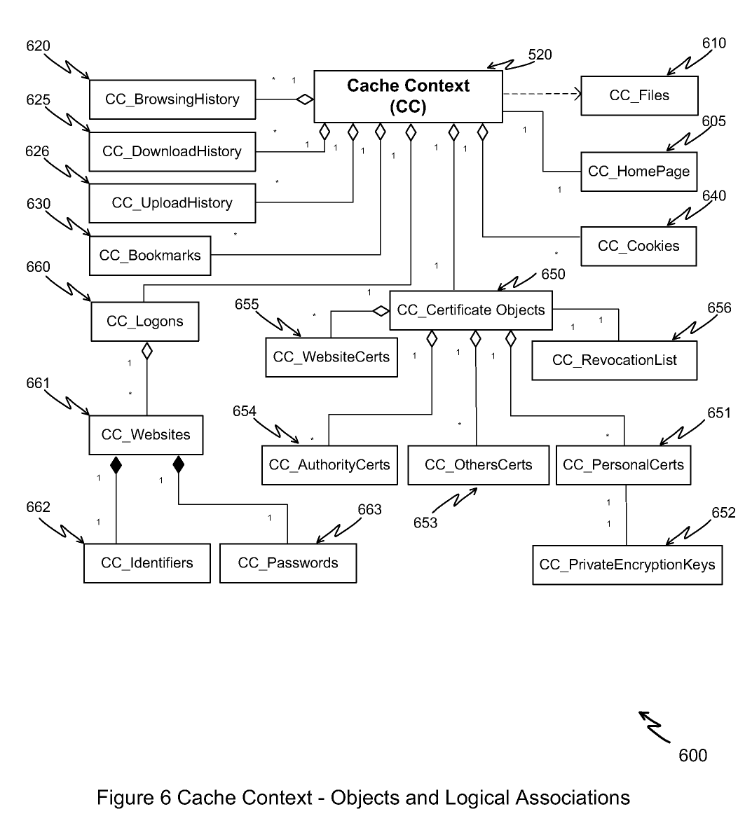

Now referring to FIG. 6 which depicts the web objects 600 of the CC 520 (cache context) of the PCD 155 (portable caching device). The CC 520 is associated with CC home page 605, CC files 610, CC browsing history 620, CC download history 625, CC upload history 626, CC bookmarks 630, and CC cookies 640. The CC 520 further has CC certificates 650 that is composed of CC personal certificates 651, CC private encryption keys 652, CC others certificates 653, CC authority certificates 654, CC web site certificates 655, and a CC revocation list 656. The CC 520 in addition has CC logons 660 composed of associated CC web sites 661, CC identifiers 662, and CC passwords 663.

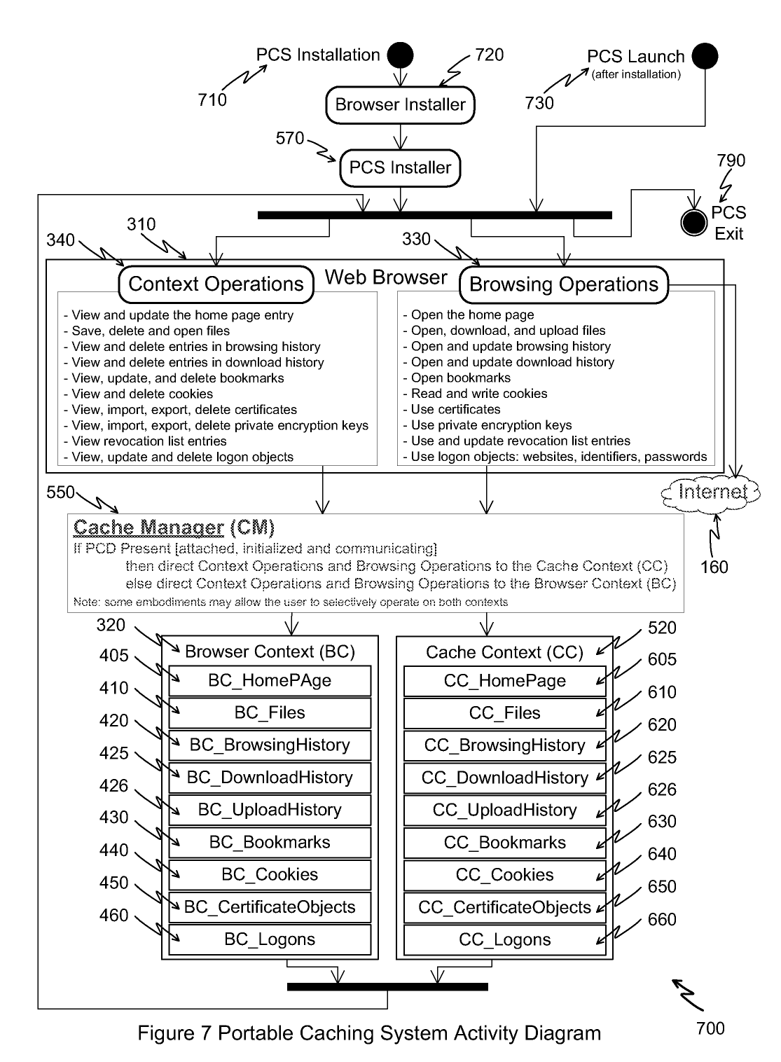

Now referring to FIG. 7 that depicts a general activity diagram 700 of the PCS. FIG. 7 depicts the installation of the prior art web browser and the installation of the inventive subject matter components depicted in FIGS. 3 through 6. Furthermore FIG. 7 depicts the operational flow of the PCS from launch to exit.

PCS installation (step 710) starts by executing web browser installer 720 which installs web browser 310 and thereby enables browsing operations 330 and context operations 340. This step is followed by executing PCS installer 570 which integrates the CM 550 (cache manager) with web browser 310 and also installs the PCD driver 560 of FIG. 5. After these steps the PCS is thereby ready for web browsing by the user as represented by PCS launch (step 730) of FIG. 7. The user's termination of web browsing is represented by PCS exit 790.

As illustrated in FIG. 7, the CM 550 first verifies if the PCD 155 is present, e.g. that the PCD 155 has been attached to the workstation 250, has been initialized, and is successfully communicating with the CM 550. If the PCD 155 is present, then the CM 550 directs browser operations 330 and context operations 340 to operate on web objects of the CC 520 (cache context) identified in FIG. 7. If the PCD 155 is not present, then the CM 550 directs browser operations 330 and context operations 340 to operate on the web objects of the BC 320 (browser context) also identified in FIG. 7.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

1. A portable caching system for internet browsing, the portable caching system comprising: a cache manager and a portable caching device.

2. The portable caching system of claim 1 wherein the cache manager is operable to exchange data with a web browser and a portable caching device.

3. The portable caching system of claim 2 wherein at least one transaction may be communicated from the web browser to the cache manager;
and the transaction is then communicated from the web browser to the portable caching device.

4. The portable caching system of claim 2 wherein at least one transaction may be communicated from the portable caching device to the cache manager;
and the transaction is then communicated from the cache manager to the web browser.

5. The portable caching system of claim 2, wherein the portable caching device further comprises a cache context.

6. The portable caching system of claim 5 wherein the cache context further comprises web objects,
such that the web objects are selected from a group consisting of the address of the home page of the user, one or more files, browsing history entries, download history entries, upload history entries, bookmarks, cookies, logon objects, and certificate objects.

7. The portable caching system of claim 6 wherein the logon objects further comprises:
one or more identifier and password pairs,
such that each identifier and password pair is associated with a website.

8. The portable caching system of claim 6 wherein the certificate objects further comprises:
one or more personal certificates,
such that each personal certificate is paired with a private encryption key of the user.

9. The portable caching system of claim 6 wherein the certificate objects are selected from the group consisting of one or more certificates of others, certificates of web sites, and certificates of authorities.

10. The portable caching system of claim 6 wherein the certificate objects further comprises a revocation list.

11. The portable caching system of claim 2 wherein the web browser further comprises:
a browser context;
context operations; and
browsing operations,
such that the context operations operate on web objects of the browser context; and
the browsing operations operate on web objects of the browser context.

12. The portable caching system of claim 11 wherein the browser context further comprises web objects;
such that the web objects are selected from the group consisting of the address of the home page of the user, one or more files, browsing history entries, download history entries, upload history entries, bookmarks, cookies, logon objects, and certificate objects.

13. The portable caching system as in claim 12 wherein the logon objects further comprises:
one or more identifier and password pairs,
such that each identifier and password pair is associated with a website.

14. The portable caching system as in claim 12 wherein the certificate objects of the browser context further comprises:
one or more personal certificates;
such that each personal certificate is paired with a private encryption key of the user.

15. The portable caching system as in claim 12 wherein the certificate objects are selected from a group consisting of one or more certificates of others, certificates of web sites, and certificates of authorities.

16. The portable caching system as in claim 12 wherein the certificate objects further comprise a revocation list.

17. A method for handling the installation of the portable caching system comprising:
integrating a software plug-in module with the web browser and a device driver; the software plug-in module comprising a cache manager, and the device driver comprising a portable caching device driver;
wherein the cache manager exchanges data with the portable caching device by means of the portable caching device driver;
initializing the portable caching device using the portable caching device driver;
initializing the cache context of the portable caching device using the portable caching device driver.

18. A method for handling internet transactions comprising the steps of:
installing a cache manager into a web browser as a plug-in module,
intercepting operations of the web browser,
detecting if a portable caching device is present,
and operating on web objects stored in a portable caching device.

19. The method for handling internet transactions as in claim 18 further comprising the steps of:
detecting if the portable caching device is present;
directing a portion of the browsing operations to a portable caching device,
operating on web objects of the cache context of the portable caching device,
performing one or more of the following steps:
open a home page;
open, download, and upload files;
open and update a browsing history entry;
open and update a download history entry;
open and update an upload history entry;
open a bookmark;
read and write a cookie;
use a certificate;
use a private encryption key;
use and update a revocation list entry; and
use a logon object;
and directing a portion of the context operations to a portable caching device,
operating on web objects of the cache context of the portable caching device, performing one or more of the following steps:
view and update a home page entry;
save, delete and open a file;
view and delete a browsing history entry;
view and delete a download history entry;
view and delete an upload history entry;
view, update, and delete a bookmark;
view and delete a cookie;
view, import, export and delete a certificate;
view, import, export and delete a private encryption key;
view a revocation list entry; and
view, update and delete a logon object.

20. The method for handling internet transactions as in claim 18 further comprising the steps of:
detecting if a portable caching device is not present,
directing one or more browsing operations and context operations to operate on the web objects of the browser context.

21. A method for processing web objects comprising the steps of:
intercepting a web browser object from a user,
routing a portion of the web browsing object to the internet,
routing a portion of the web browser object to a browser context,
so that a portion of the web browser object is stored in a portable caching device.
